(19) United States
(12) Patent Application Publication
(10) Pub. No.: US 2024/0336261 A1
(43) Pub. Date: Oct. 10, 2024

(54) VEHICLE AND METHOD CONTROLLING VEHICLE SPEED

(71) Applicants: Hyundai Motor Company, Seoul (KR); Kia Corporation, Seoul (KR)

(72) Inventors: Ye Chan JEONG, Seoul (KR); Hui Un SON, Suwon-si (KR); Sung Bae JEON, Hwaseong-si (KR)

(73) Assignees: Hyundai Motor Company, Seoul (KR); Kia Corporation, Seoul (KR)

(21) Appl. No.: 18/373,454

(22) Filed: Sep. 27, 2023

(30) Foreign Application Priority Data
Apr. 10, 2023 (KR) 10-2023-0046884

(51) Int. Cl. B60W 30/14; B60W 30/18

(52) U.S. Cl. CPC B60W 30/143; B60W 30/18163; B60W 2520/105; B60W 2540/106; B60W 2554/4041; B60W 2554/4045; B60W 2554/80

(57) ABSTRACT

A vehicle speed control method includes the steps of: limiting the acceleration of a pertinent vehicle according to an acceleration limitation level which has been set based on a predetermined command; and adjusting the acceleration limitation level based on a first parameter regarding a driver's request for acceleration and a second parameter regarding the traveling state of a peripheral vehicle when a preset acceleration limitation alleviation condition is satisfied.

### CROSS-REFERENCE TO RELATED APPLICATION(S)

This application is based on and claims priority under 35 U.S.C. 119 to Korean Patent Application No. 10-2023-0046884, filed on Apr. 10, 2023, in the Korean Intellectual Property Office, the disclosure of which is herein incorporated by reference in its entirety.

### TECHNICAL FIELD

The present disclosure relates to a vehicle configured to perform acceleration limit control and a vehicle speed control method.

### BACKGROUND

Acceleration limit control (ALC) of a vehicle refers to a technology wherein, when the driver manipulates the accelerator pedal, the current acceleration of the vehicle is controlled not to exceed the acceleration limit set by the driver. Recently, various derivative technologies have been developed by using the smooth acceleration feeling provided by the ALC, such as a mode for infants or beginner drivers.

In general, the ALC limits the upper limit of the current acceleration to the acceleration limit set by the driver's command, and it may thus be difficult to flexibly limit the acceleration limit in response to the driver's request for acceleration limitation alleviation or according to various traveling states of peripheral vehicles. For example, it may be difficult to flexibly limit the current acceleration of the vehicle in a situation requiring rapid acceleration due to the peripheral traffic situation, such as a situation in which the driver intends to change lanes when there is a rear/lateral vehicle approaching the pertinent vehicle.

The above descriptions regarding background technologies have been made only to help understanding of the background of the present disclosure, and are not to be deemed by those skilled in the art to correspond to already-known prior arts.

SUMMARY DISCLOSURE A technical problem to be solved by the present disclosure is to adjust the acceleration limitation level based on the driver's request for acceleration and the traveling state of peripheral vehicles until a preset acceleration limitation alleviation condition is satisfied, thereby flexibly alleviating the acceleration limitation in a situation requiring rapid acceleration due to peripheral traffic situations.

The technical subjects pursued in the present disclosure may not be limited to the above mentioned technical subjects, and other technical subjects which are not mentioned may be clearly understood, through the following descriptions, by those skilled in the art to which the present disclosure pertains.

In order to solve the above-mentioned technical problems, a vehicle speed control method may include: limiting the acceleration of a pertinent vehicle according to an acceleration limitation level which has been set based on a predetermined command; and adjusting the acceleration limitation level based on a first parameter regarding a driver's request for acceleration and a second parameter regarding the traveling state of a peripheral vehicle when a preset acceleration limitation alleviation condition is satisfied.

In addition, in order to solve the above-mentioned technical problems, a vehicle may include: an acceleration limitation device configured to limit the acceleration of a pertinent vehicle according to an acceleration limitation level; and an acceleration limitation level setup device configured to set the acceleration limitation level according to a predetermined command and configured to adjust the acceleration limitation level based on a first parameter regarding a driver's request for acceleration and a second parameter regarding the traveling state of a peripheral vehicle when a preset acceleration limitation alleviation condition is satisfied.

The present disclosure is advantageous in that the acceleration limitation level is adjusted based on the driver's request for acceleration and the traveling state of peripheral vehicles until a preset acceleration limitation alleviation condition is satisfied, thereby flexibly alleviating the acceleration limitation in a situation requiring rapid acceleration due to peripheral traffic situations.

Advantageous effects obtainable from the present disclosure may not be limited to the above mentioned effects, and other effects which are not mentioned may be clearly understood, through the following descriptions, by those skilled in the art to which the present disclosure pertains.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram illustrating a vehicle acceleration limitation system according to an embodiment of the present disclosure;

FIG. 2 illustrates a process in which a vehicle according to an embodiment of the present disclosure performs acceleration limit control;

FIG. 3 is a block diagram illustrating the configuration of an acceleration limitation alleviation assessment unit according to an embodiment of the present disclosure;

FIG. 4 is a block diagram illustrating the configuration of an acceleration limitation level assessment unit according to an embodiment of the present disclosure;

FIG. 5 and FIG. 6 illustrate a process in which a vehicle acceleration is controlled in an embodiment of the present disclosure; and

FIG. 7 is a flowchart illustrating a vehicle speed control method according to an embodiment of the present disclosure.

### DETAILED DESCRIPTION OF THE EXEMPLARY EMBODIMENTS

Hereinafter, embodiments disclosed in the present specification will be described in detail with reference to the accompanying drawings, and the same or similar elements are given the same and similar reference numerals, so duplicate descriptions thereof will be omitted.

In describing the embodiments disclosed in the present specification, when the detailed description of the relevant known technology is determined to unnecessarily obscure the gist of the present disclosure, the detailed description may be omitted. Furthermore, the accompanying drawings are provided only for easy understanding of the embodiments disclosed in the present specification, and the technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for the purpose of distinguishing one element from another element.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

In addition, a unit or a control unit included in names is merely a term widely used for naming a controller configured to control a specific function of a vehicle, but does not mean a generic function unit.

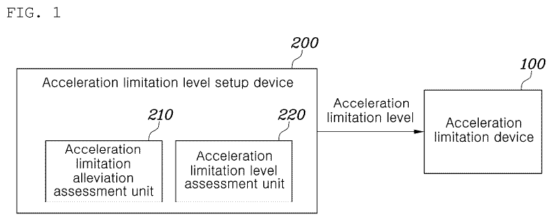

FIG. 1 is a block diagram illustrating a vehicle acceleration limitation system according to an embodiment of the present disclosure.

Referring to FIG. 1, the vehicle acceleration limitation system according to an embodiment of the present disclosure may include an acceleration limitation device 100 configured to limit the vehicle acceleration according to an acceleration limitation level and an acceleration limitation level setup device 200 configured to set the acceleration limitation level. The acceleration limitation device 100 and acceleration limitation level setup device 200 according to an exemplary embodiment of the present disclosure may be a hardware device implemented by various electronic circuits (e.g., computer, microprocessor, CPU, ASIC, circuitry, logic circuits, etc.). The acceleration limitation device 100 and acceleration limitation level setup device 200 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s).

The acceleration limitation system may perform acceleration limit control (ALC) such that the acceleration limitation level setup device 200 sets an acceleration limitation level on the basis of the driver's command, and the acceleration limitation device 100 limits the vehicle acceleration according to the acceleration limitation level that has been set.

The present embodiment proposes an acceleration limitation system configured to adjust the acceleration limitation level on the basis of the driver's request for acceleration and the traveling state of peripheral vehicles such that, in a situation requiring rapid acceleration due to peripheral traffic situations, acceleration limitation by the acceleration limit control (ALC) is alleviated.

To this end, the acceleration limitation level setup device 200 may include an acceleration limitation alleviation assessment unit 210 configured to assess the level of the driver's request for acceleration, if any, and an acceleration limitation level assessment unit 220 configured to assess the traveling state of peripheral vehicles and to set an acceleration limitation level.

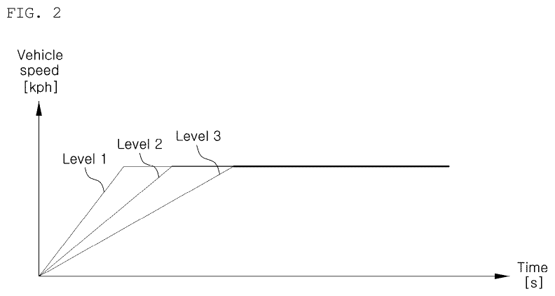

FIG. 2 illustrates a process in which a vehicle according to an embodiment of the present disclosure performs acceleration limit control.

FIG. 2 illustrates vehicle acceleration limits according to acceleration limitation levels. The acceleration limitation levels may include a first level (LEVEL 1), a second level (LEVEL 2), and a third level (LEVEL 3), but the number of levels may be variously set depending on the embodiment. In the present embodiment, the vehicle acceleration limit is set to be proportional to the acceleration limitation level, but the vehicle acceleration limit may be set to be inversely proportional to the acceleration limitation level, depending on the embodiment.

Hereinafter, the configuration of the acceleration limitation level setup device 200 configured to set the acceleration limitation level according to the present disclosure and a method for operating the same will be described in detail.

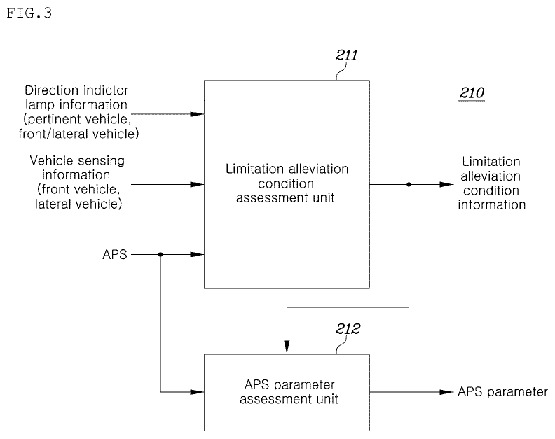

FIG. 3 is a block diagram illustrating the configuration of an acceleration limitation alleviation assessment unit according to an embodiment of the present disclosure.

Referring to FIG. 3, the acceleration limitation alleviation assessment unit 210 according to an embodiment of the present disclosure may include a limitation alleviation condition assessment unit 211 configured to confirm whether a preset acceleration limitation alleviation condition is satisfied, and an APS parameter assessment unit 212 configured to assess an APS parameter regarding the deriver's request for acceleration.

The limitation alleviation condition assessment unit 211 may confirm whether a preset acceleration alleviation condition is satisfied on the basis of direction indicator lamp information, vehicle sensing information, and accelerator pedal sensing value (APS value), and may output the result of confirmation as limitation alleviation condition information. The direction indicator lamp information may include information regarding direction indicator lamps of the pertinent vehicle and those of front/lateral vehicles located on the front/lateral sides of the pertinent vehicle, and the vehicle sensing information may include sensing information regarding front vehicles located in front of the pertinent vehicle and lateral vehicles located on sides thereof.

In the present embodiment, the preset acceleration alleviation condition may include a condition that the pertinent vehicle changes lanes, a condition that a front/lateral vehicle located on a front/lateral side of the pertinent vehicle changes lanes and moves into the lane along which the pertinent vehicle currently travels, and a condition that the pertinent vehicle requires additional acceleration.

The condition that the pertinent vehicle changes lanes may correspond to a condition for alleviating the acceleration limitation in a situation requiring rapid acceleration of the pertinent vehicle due to a rear/lateral vehicle located on a rear/lateral side of the pertinent vehicle when the pertinent vehicle changes lanes. The condition that the pertinent vehicle changes lanes may be assessed on the basis of whether a direction indicator lamp of the pertinent vehicle is blinking, whether a direction indicator lamp of the pertinent vehicle keeps blinking for a predetermined period of time, whether an instantaneous change rate of the accelerator pedal sensing value (APS value) exceeds a threshold, and whether rear/lateral vehicles are sensed. For example, the limitation alleviation condition assessment unit 211 may confirm that acceleration limitation alleviation is required if the above-mentioned four assessment conditions are all satisfied.

The condition that a front/lateral vehicle changes lanes may correspond to a condition that, when the front/lateral vehicle wants to change lanes and to move into the lane along which the pertinent vehicle currently travels, the pertinent vehicle needs to suppress the lane change of the front/lateral vehicle. The condition that the front/lateral vehicle changes lanes may be assessed on the basis of whether a direction indicator lamp of the front/lateral vehicle is blinking, whether a direction indicator lamp of the front/lateral vehicle keeps blinking for a predetermined period of time, whether an instantaneous change rate of the accelerator pedal sensing value exceeds a threshold, and whether a front vehicle located in front of the pertinent vehicle is sensed along the traveling lane of the pertinent vehicle. For example, the limitation alleviation condition assessment unit 211 may confirm that acceleration limitation alleviation is required if the above-mentioned four assessment conditions are all satisfied.

The condition that the pertinent vehicle requires additional acceleration may correspond to a condition that, in a situation in which the acceleration of the pertinent vehicle relative to a front vehicle is low, the pertinent vehicle requires acceleration limitation alleviation. The condition that the pertinent vehicle requires additional acceleration may be assessed on the basis of whether the pertinent vehicle and the front vehicle maintain the traveling lane, whether the acceleration of the pertinent vehicle relative to the front vehicle is below a predetermined acceleration, and whether an instantaneous change rate of the accelerator pedal sensing value exceeds a threshold. For example, the limitation alleviation condition assessment unit 211 may confirm that acceleration limitation alleviation is required if the above-mentioned three assessment conditions are all satisfied.

The APS parameter assessment unit 212 may assess an APS parameter regarding the deriver's request for acceleration on the basis of limitation alleviation condition information, the amount of instantaneous change of the accelerator pedal sensing value (APS value), and a maintenance time during which the accelerator pedal sensing value (APS value) is included in a predetermined range.

For example, the APS parameter assessment unit 212 may calculate the APS parameter value as in Equation 1 below if the condition that the pertinent vehicle changes lanes or the condition that the front/lateral vehicle changes lanes.

APS parameter value=“G1”×“amount of instantaneous change APS value”+“G2”×“maintenance time during which APS value is included in predetermined range” Equation 1:

In addition, the APS parameter assessment unit 212 may calculate the APS parameter value as in Equation 2 below if the condition that the pertinent vehicle requires additional acceleration is satisfied.

APS parameter value=“G3”×“amount of instantaneous change APS value”+“G4”×“maintenance time during which APS value is included in predetermined range” Equation 2:

It may be understood that the driver's intent on acceleration alleviation is proportional to the APS parameter value. The condition that the pertinent vehicle requires additional acceleration corresponds to a condition that the deriver wants to get out of the situation in which he/she feels stuck because the acceleration of the pertinent vehicle relative to the front vehicle is low, and the APS instantaneous change rate may have a higher importance than the lane change. Therefore, the value of G3 may be set to be larger than the value of G1, but is not necessarily limited thereto.

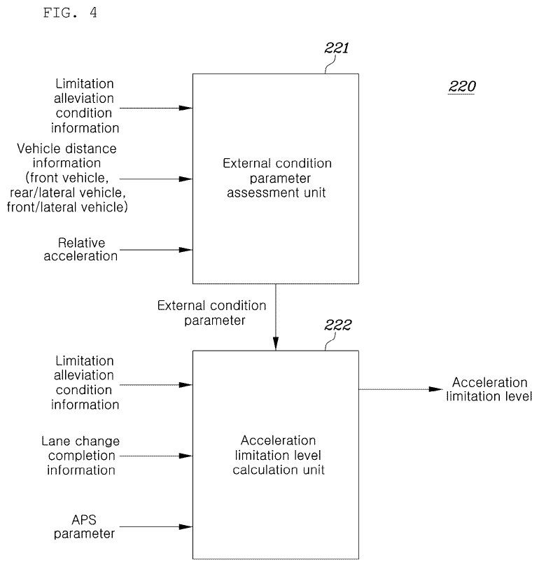

FIG. 4 is a block diagram illustrating the configuration of an acceleration limitation level assessment unit according to an embodiment of the present disclosure.

Referring to FIG. 4, the acceleration limitation level assessment unit 220 according to an embodiment of the present disclosure may include an external condition parameter assessment unit 221 configured to assess external condition parameters regarding the traveling state of peripheral vehicles, and an acceleration limitation level calculation unit 222 configured to calculate the acceleration limitation level on the basis of APS parameters and external condition parameters.

The external condition parameter assessment unit 221 may assess external condition parameters on the basis of limitation alleviation condition information, vehicle distance information, and the acceleration of the pertinent vehicle relative to peripheral vehicles. The value of an external condition parameter may be understood as the extent to which acceleration limitation of the pertinent vehicle needs to be alleviated according to external conditions (that is, the traveling state of peripheral vehicles). The vehicle distance information may include information regarding the distance between the pertinent vehicle and a front vehicle, the distance between the pertinent vehicle and a rear/lateral vehicle, and the distance between the pertinent vehicle and a front/lateral vehicle.

If the condition that the pertinent vehicle changes lanes or the condition that the front/lateral vehicle changes lanes is satisfied, the external condition parameter assessment unit 221 may calculate the external condition parameter value as in Equation 3 below. The value of weights K1, K2, K3, and K4 may be variously set depending on the embodiment.

external condition parameter value=“K1”×“A”+“K2”×“B”+“K3”×“C”+“K4”×“D” Equation 3:

“A” may be calculated in view of the distance between the pertinent vehicle and the front vehicle. For example, the value of “A” may be “3” if the distance between the pertinent vehicle and the front vehicle is less than 50 m, may be “2” if the distance between the pertinent vehicle and the front vehicle is between 50 m and 100 m, and may be “1” if the distance between the pertinent vehicle and the front vehicle exceeds “100 m”.

“B” may be calculated in view of the distance between the pertinent vehicle and a peripheral vehicle. The peripheral vehicle may be a rear/lateral vehicle when the pertinent vehicle changes lanes, and may be a front/lateral vehicle when the front/lateral vehicle changes lanes. For example, the value of “B” may be “3” if the distance between the pertinent vehicle and the rear/lateral (front/lateral) vehicle is less than 5 m, may be “2” if distance between the pertinent vehicle and the rear/lateral (front/lateral) vehicle is between 5 m and 10 m, and may be “1” if distance between the pertinent vehicle and the rear/lateral (front/lateral) vehicle exceeds 10 m.

“C” may be calculated in view of the acceleration of the pertinent vehicle relative to a peripheral vehicle. For example, the value of “C” may be “3” if the relative acceleration is less than 1 m/s\hat{ }2 may be “2” if the relative acceleration is between 1 m/s\hat{ }2 and 2 m/s\hat{ }2, and may be “1” if the relative acceleration exceeds 2 m/s\hat{ }2.

“D” may be calculated in view of a maintenance time during which the relative acceleration is included in a predetermined range. For example, the value of “D” may be “3” if the maintenance time exceeds 2 seconds, may be “2” if the maintenance time is between 1 second and 2 seconds, and may be “1” if the maintenance time is less than 1 second.

If the condition that the pertinent vehicle requires additional acceleration is satisfied, the external condition parameter assessment unit 221 may calculate the APS parameter value as in Equation 4 below. The value of weights K5, K6, and K7 may be variously set depending on the embodiment.

external condition parameter value=“K5”×“E”+“K6”×“F”+“K7”×“G” Equation 4:

“E” may be calculated in view of the distance between the pertinent vehicle and the front vehicle. For example, the value of “E” may be “3” of the distance between the pertinent vehicle and the front vehicle exceeds 100 m, may be “2” if the distance between the pertinent vehicle and the front vehicle is between 50 m and 100 m, and may be “1” if the distance between the pertinent vehicle and the front vehicle exceeds 50 m.

“F” may be calculated in view of the acceleration of the pertinent vehicle relative to the front vehicle. For example, the value of “F” may be “3” if the relative acceleration is less than 1 m/s\hat{ }2, may be “2” if the relative acceleration is between 1 m/s\hat{ }2 and 2 m/s\hat{ }2, and may be “1” if the relative acceleration exceeds 2 m/s\hat{ }2.

“G” may be calculated in view of a maintenance time during which the relative acceleration corresponds to a predetermined acceleration or higher. For example, the value of “G” may be “3” if the maintenance time exceeds 2 seconds, may be “2” if the maintenance time is between 1 second and 2 seconds, and may be “1” if the maintenance time is less than 1 second.

The acceleration limitation level calculation unit 222 may calculate the acceleration limitation level on the basis of limitation alleviation condition information, lane change completion information, APS parameters, and external condition parameters. If a preset limitation alleviation condition is satisfied, the acceleration limitation level calculation unit 222 may adjust the acceleration limitation level on the basis of an APS parameter regarding the driver's request for acceleration and an external condition parameter regarding the traveling state of a peripheral vehicle. More specifically, the acceleration limitation level calculation unit 222 may adjust the acceleration limitation level so as to decrease such that the upper limit of acceleration increases in proportion to the APS parameter value. In addition, the acceleration limitation level calculation unit 222 may adjust the acceleration limitation level so as to decrease such that the upper limit of acceleration increases in proportion to the external condition parameter value. As described value, the APS parameter value may be proportional to the amount of instantaneous change of the accelerator pedal sensing value (APS value), and the external condition parameter value may be inversely proportional to the acceleration of the pertinent vehicle relative to a peripheral vehicle.

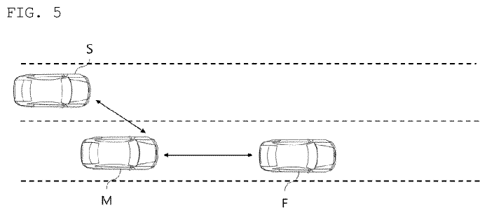

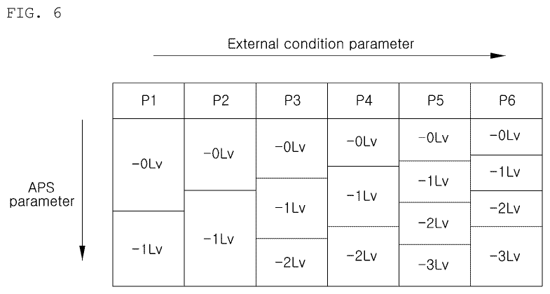

FIG. 5 and FIG. 6 illustrate a process in which a vehicle acceleration is controlled in an embodiment of the present disclosure.

Referring to FIG. 5, a process in which the pertinent vehicle M changes traveling lanes is illustrated. The limitation alleviation condition assessment unit 211 may confirm whether a condition for the pertinent vehicle M to change lines is satisfied, on the basis of whether a direction indicator lamp of the pertinent vehicle M is blinking, whether a direction indicator lamp of the pertinent vehicle M keeps blinking for a predetermined period of time, whether the instantaneous change rate of the accelerator pedal sensing value (APS value) exceeds a threshold, and whether a rear/lateral vehicle S is sensed in a lane along which the pertinent vehicle M is supposed to travel after a lane change.

If the condition for the pertinent vehicle M to change lines is satisfied, the APS parameter assessment unit 212 may assess the APS parameter as in Equation 1 below, on the basis of the accelerator pedal sensing value (APS value). For example, the APS parameter value may correspond to 65 when “G1” and “G2” may correspond to “1.5” and “1.0” respectively, when the amount of instantaneous change of the APS value corresponds to 30, and the APS maintenance time corresponds to 2 seconds.

APS parameter value=“G1”×“amount of instantaneous change of APS value”+“G2”×“maintenance time during which APS value is included in predetermined range” Equation 1:

In addition, if the condition for the pertinent vehicle M to change lines is satisfied, the external condition parameter assessment unit 221 may assess the external condition parameter as in Equation 3 below. For example, the external condition parameter value may correspond to 14 when “K1”, “K2”, “K3”, and “K4” correspond to “1.0”, “1.5”, “2.0”, and “2.5”, respectively, when the value of “A” is “1” because the distance between the pertinent vehicle M and the front vehicle F exceeds 100 m, when the value of “B” is “3” because the distance between the pertinent vehicle M and the rear/lateral vehicle S is less than 5 m, when the value of “C” is “3” because the acceleration of the pertinent vehicle M relative to the rear/lateral vehicle S is less than 1 m/s\hat{ }2, and when the value of “D” is “1” because the relative acceleration maintenance time is less than 1 second.

external condition parameter value=“K1”×“A”+“K2”×“B”+“K3”×“C”+“K4”×“D” Equation 3:

Thereafter, the acceleration limitation level calculation unit 222 may assess the acceleration limitation level on the basis of the APS parameter value and the external condition parameter value.

FIG. 6 illustrates an acceleration limitation level that is adjusted according to the APS parameter value and the external condition parameter value. “P1”, “P2”, “P3”, “P4”, “P5”, and “P6” may correspond to intervals regarding the external condition parameter value. For example, if the external condition parameter value corresponds to “14”, the acceleration limitation level calculation unit 222 may adjust the acceleration limitation level on the basis of P3 that corresponds to the interval of 10 to 15.

An option to trigger acceleration limitation alleviation may be selected from “upper”, “middle”, and “lower” according to the driver's setting. If the trigger option corresponds to “upper”, acceleration limitation may be alleviated in all intervals of P1-P6, if the trigger option corresponds to “middle”, acceleration limitation may be alleviated in intervals of P3-P6, and if the trigger option corresponds to “lower”, acceleration limitation may be alleviated only in intervals of P5-P6.

Thereafter, the acceleration limitation level calculation unit 222 may gradually lower the acceleration limitation level as the APS parameter has a large value in P3 (that is, as the driver's request for acceleration has a high level).

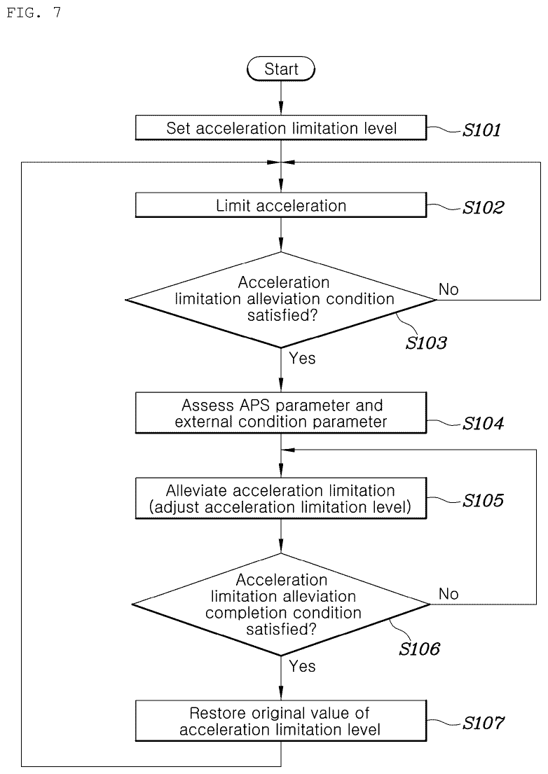

FIG. 7 is a flowchart illustrating a vehicle speed control method according to an embodiment of the present disclosure.

Referring to FIG. 7, an acceleration limitation level may be set according to the driver's command (S101), and the acceleration limitation device 100 may limit the acceleration of the pertinent vehicle according to the acceleration limitation level that has been set (S102).

Thereafter, the limitation alleviation condition assessment unit 211 may confirm whether a preset acceleration limitation alleviation condition is satisfied (S103).

If the preset acceleration limitation alleviation condition is satisfied (YES in S103), the APS parameter assessment unit 212 may assess an APS parameter regarding the deriver's request for acceleration, and the external condition parameter assessment unit 221 may calculate an external condition parameter regarding the traveling state of peripheral vehicles (S104).

The acceleration limitation level calculation unit 222 may adjust the acceleration limitation level in order to alleviate acceleration limitation on the basis of the APS parameter and the external condition parameter (S105).

Thereafter, the acceleration limitation level calculation unit 222 may confirm that a condition to end acceleration limitation alleviation is satisfied if the lane change is completed, or if the distance from the front vehicle is equal to/less than a predetermined distance (S106), and may restore the original value of the adjusted acceleration limitation level (S107).

The present disclosure as described above may be implemented as codes in a computer-readable medium in which a program is recorded. The computer-readable medium includes all types of recording devices in which data readable by a computer system are stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. Further, the above detailed description should not be construed in a limitative sense, but should be considered in an illustrative sense in all aspects. The scope of the present disclosure should not be determined by reasonable interpretation of the appended claims, and all changes and modifications within the equivalent scope of the present disclosure fall within the scope of the present disclosure.

What is claimed is:

1. A vehicle speed control method comprising:
limiting acceleration of a pertinent vehicle according to an acceleration limitation level which has been set based on a predetermined command; and
adjusting the acceleration limitation level based on a first parameter regarding a driver's request for acceleration and a second parameter regarding the traveling state of a peripheral vehicle when a preset acceleration limitation alleviation condition is satisfied.

2. The vehicle speed control method of claim 1, wherein the preset acceleration limitation alleviation condition comprises a condition that the pertinent vehicle changes lanes, and
the condition that the pertinent vehicle changes lanes is determined based on at least one of whether a direction indicator lamp of the pertinent vehicle is blinking, whether the direction indicator lamp of the pertinent vehicle keeps blinking for a predetermined period of time, whether an instantaneous change rate of an accelerator pedal sensing value exceeds a threshold, and whether a rear and lateral vehicle located on a rear and lateral side of the pertinent vehicle is sensed.

3. The vehicle speed control method of claim 1, wherein the preset acceleration limitation alleviation condition comprises a condition that a front and lateral vehicle located on a front and lateral side of the pertinent vehicle changes lanes and moves into a traveling lane of the pertinent vehicle, and
the condition that the front and lateral vehicle changes lanes is determined based on at least one of whether a direction indicator lamp of the front and lateral vehicle is blinking, whether the direction indicator lamp of the front and lateral vehicle keeps blinking for a predetermined period of time, whether an instantaneous change rate of an accelerator pedal sensing value exceeds a threshold, and whether a front vehicle located in front of the pertinent vehicle is sensed in the traveling lane of the pertinent vehicle.

4. The vehicle speed control method of claim 1, wherein the preset acceleration limitation alleviation condition comprises a condition that the pertinent vehicle requires additional acceleration, and
the condition that the pertinent vehicle requires additional acceleration is determined based on at least one of whether the pertinent vehicle and a front vehicle located in front of the pertinent vehicle maintain a traveling lane, whether the acceleration of the pertinent vehicle relative to the front vehicle is less than a predetermined acceleration, and whether an instantaneous change rate of an accelerator pedal sensing value exceeds a threshold.

5. The vehicle speed control method of claim 1, further comprising: determining the first parameter based on an amount of instantaneous change of an accelerator pedal sensing value and a maintenance time during which the accelerator pedal sensing value is included in a predetermined range.

6. The vehicle speed control method of claim 1, further comprising: determining the second parameter based on a distance between the pertinent vehicle and a peripheral vehicle and the acceleration of the pertinent vehicle relative to the peripheral vehicle.

7. The vehicle speed control method of claim 1, wherein the adjusting the acceleration limitation level further comprises: adjusting the acceleration limitation level such that an upper limit of the acceleration is set to be proportional to a value of the first parameter, and
the value of the first parameter is proportional to an amount of instantaneous change of an accelerator pedal sensing value.

8. The vehicle speed control method of claim 1, wherein the adjusting the acceleration limitation level further comprises: adjusting the acceleration limitation level such that an upper limit of the acceleration is set to be proportional to a value of the second parameter, and
the value of the second parameter is inversely proportional to the acceleration of the pertinent vehicle relative to the peripheral vehicle.

9. A computer-readable recording medium in which a program for executing the vehicle speed control method of one of claims 1 to 8 is recorded.

10. A vehicle comprising:
an acceleration limitation device configured to limit acceleration of a pertinent vehicle according to an acceleration limitation level; and
an acceleration limitation level setup device configured to set the acceleration limitation level according to a predetermined command and configured to adjust the acceleration limitation level based on a first parameter regarding a driver's request for acceleration and a second parameter regarding the traveling state of a peripheral vehicle when a preset acceleration limitation alleviation condition is satisfied.

11. The vehicle of claim 10, wherein the preset acceleration limitation alleviation condition comprises a condition that the pertinent vehicle changes lanes, and
the acceleration limitation level setup device is configured to determine the condition that the pertinent vehicle changes lanes based on at least one of whether a direction indicator lamp of the pertinent vehicle is blinking, whether the direction indicator lamp of the pertinent vehicle keeps blinking for a predetermined period of time, whether an instantaneous change rate of an accelerator pedal sensing value exceeds a threshold, and whether a rear and lateral vehicle located on a rear and lateral side of the pertinent vehicle is sensed.

12. The vehicle of claim 10, wherein the preset acceleration limitation alleviation condition comprises a condition that a front and lateral vehicle located on a front and lateral side of the pertinent vehicle changes lanes and moves into a traveling lane of the pertinent vehicle, and
the acceleration limitation level setup device is configured to determine the condition that the front and lateral vehicle changes lanes based on at least one of whether a direction indicator lamp of the front and lateral vehicle is blinking, whether the direction indicator lamp of the front and lateral vehicle keeps blinking for a predetermined period of time, whether an instantaneous change rate of an accelerator pedal sensing value exceeds a threshold, and whether a front vehicle located in front of the pertinent vehicle is sensed in the traveling lane of the pertinent vehicle.

13. The vehicle of claim 10, wherein the preset acceleration limitation alleviation condition comprises a condition that the pertinent vehicle requires additional acceleration, and
the acceleration limitation level setup device is configured to determine the condition that the pertinent vehicle requires additional acceleration based on at least one of whether the pertinent vehicle and a front vehicle located in front of the pertinent vehicle maintain a traveling lane, whether the acceleration of the pertinent vehicle relative to the front vehicle is less than a predetermined acceleration, and whether an instantaneous change rate of an accelerator pedal sensing value exceeds a threshold.

14. The vehicle of claim 10, wherein the acceleration limitation level setup device is configured to determine the first parameter based on an amount of instantaneous change of an accelerator pedal sensing value and a maintenance time during which the accelerator pedal sensing value is included in a predetermined range.

15. The vehicle of claim 10, wherein the acceleration limitation level setup device is configured to determine the second parameter based on a distance between the pertinent vehicle and a peripheral vehicle and the acceleration of the pertinent vehicle relative to the peripheral vehicle.

16. The vehicle of claim 10, wherein the acceleration limitation level setup device is configured to adjust the acceleration limitation level such that an upper limit of the acceleration is set to be proportional to a value of the first parameter, and
the value of the first parameter is proportional to the amount of instantaneous change of an accelerator pedal sensing value.

17. The vehicle of claim 10, wherein the acceleration limitation level setup device is configured to adjust the acceleration limitation level such that an upper limit of the acceleration is set to be proportional to a value of the second parameter, and
the value of the second parameter is inversely proportional to the acceleration of the pertinent vehicle relative to the peripheral vehicle.
